(19) United States
(12) Patent Application Publication
(10) Pub. No.: US 2006/0027052 A1
(43) Pub. Date: Feb. 9, 2006

(54) Adjustable wrench

(76) Inventor: Robert V. Rhodes, South Pasadena, CA (US)

Correspondence Address: JAMES E. BRUNTON, ESQ., P. O. BOX 29000, GLENDALE, CA, 91209, US

(21) Appl. No.: 10/912,925

(22) Filed: Aug. 6, 2004

(51) Int. Cl. B25B 13/16

(52) U.S. Cl. 81/156; 81/165; 81/175

(57) ABSTRACT

An adjustable rack type crescent wrench that allows the user to quickly and easily change the distance between the jaws of the wrench and then to automatically engage a nut or bolt head when the wrench is in position. The wrench includes an internal spring type mechanism that is engineered and designed to engage one end of the movable jaw assembly so that when the jaw is extended into the open position, it can then be released by the user pressing down on an operator mechanism that releases the worm gear from the rack of the movable jaw which instantly adjusts the distance between the jaws in a manner to securely grasp the flat portions of a nut bolt head or like fastener, while still allowing final, slight, adjustments to the position of the jaws by virtue of the ability to manipulate the sliding jaw with the worm gear.

### BACKGROUND OF THE INVENTION

1. Field of the Invention

The invention relates generally to the field of wrenches and more specifically to an adjustable crescent type wrench. Crescent wrenches are well known. They generally come in sets from small to large so that the user can select the proper wrench for the nut that is to be tightened or loosened.

2. Discussion of Prior Art

Standard adjustable crescent wrenches include an adjustable jaw that can be positioned in or out with respect to a fixed jaw when the user turns a “worm type gear” that is engaged with a rack portion located on a horizontal sliding member that is integral with the adjustable jaw of the wrench. These type of wrenches are helpful in that one wrench can take the place of an entire set of standard open ended wrenches. In the operation of a conventional “worm gear” adjustable wrench, there is a tendency for the movable jaw portion of the wrench to loosen during the process of the tightening or loosening of the nut or bolt head.

In an improved wrench design disclosed in International Patent Publication WO-03/01826A1, this problem was sought to be overcome by developing a wrench that can be adjusted by disengaging the pawl on the bottom of the adjustable jaw, from the rack which is integral to the fixed jaw. This is accomplished by pulling down on a button member designed to disengage the pawl from the rack so that the moveable portion of the wrench jaw could then be pushed or pulled to the desired location at which point the button is then released reengaging the pawl and rack thus securing both jaws of the wrench on a nut or bolt head.

The disadvantage inherent in this procedure, however, is that it takes two hands to accomplish the adjustment of the moveable jaw, one hand to hold the wrench and the other hand to manually adjust the moveable jaw to the desired distance between the jaws and then to close the jaw against the nut or bolt head. This can be a drawback where a one-handed jaw closing operation is desired, needed or required. For example, if a person is reaching behind a machine where there is a wall in close proximity to the back of the machine, or on other equipment where working space is too tight or at a premium, the user may not have room to reach in with the other hand to move the adjustable jaw into position against the nut or bolt head.

### SUMMARY OF THE INVENTION

It is an object of the present invention to provide an adjustable rack type crescent wrench that allows the user to quickly and easily change the distance between the jaws of the wrench and then to automatically engage a nut or bolt head when the wrench is in position. This objective is achieved through the design of an internal spring type mechanism that is engineered and designed to engage one end of the moveable jaw assembly so that when the jaw is extended into the open position, it can then be released by the user pressing down on an operator mechanism that releases the worm gear from the rack of the movable jaw which instantly adjusts the distance between the jaws in a manner to securely grasp the flat portions of a nut, bolt head or like fastener.

Another objective of the invention is to provide an adjustable wrench of the aforementioned character that is easy to use and reliable in operation.

Another object of the invention, is to provide an adjustable wrench as described in the preceding paragraphs that is of a simple design and one that can be inexpensively manufactured.

### BRIEF DESCRIPTION OF THE DRAWINGS

FIG. 1 is a front view of one form of the adjustable wrench of the invention, partly broken away to show internal construction.

FIG. 1A is a view taken along lines 1A-1A of FIG. 1.

FIG. 2 is a cross-sectional view taken along lines 2-2 of FIG. 1A.

FIG. 3 is a generally perspective, fragmentary view of the operator assemblage of the adjustable wrench of the invention.

FIG. 4 is a cross-sectional view similar to FIG. 2, but showing the operator assemblage in a retracted position and showing the jaws in an open position.

FIG. 5 is a cross-sectional view similar to FIG. 2, but showing the operator assemblage in an operating position and showing the jaws in a closed position.

FIG. 6 is a cross-sectional view taken along lines 6-6 of FIG. 5.

### DESCRIPTION OF THE INVENTION

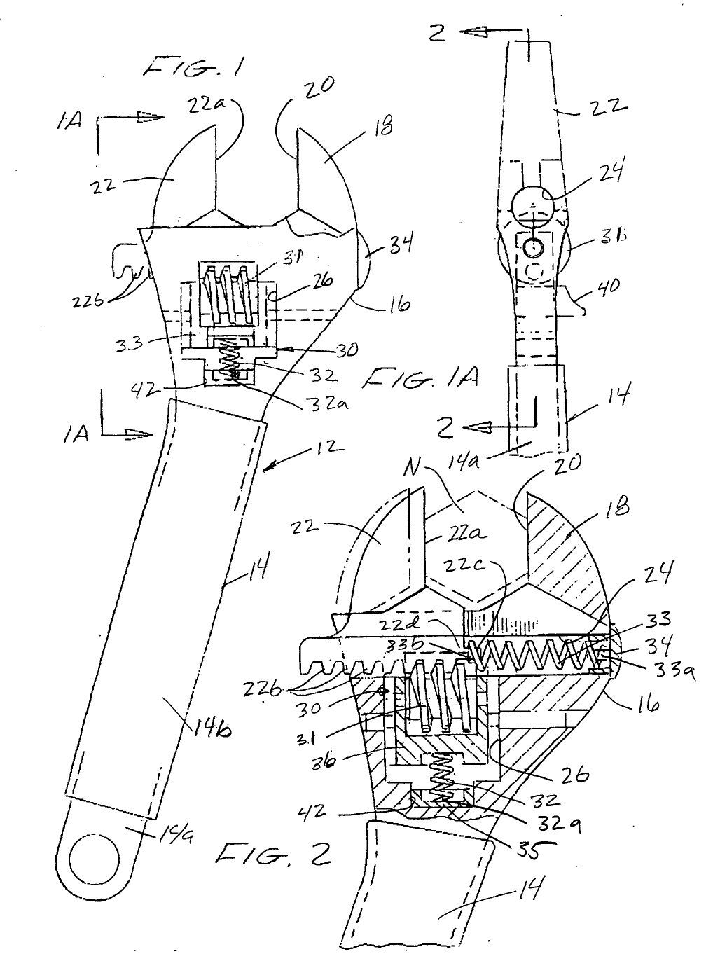

Referring to the drawings and particularly to FIGS. 1 through 3, one form of the adjustable wrench of the present invention is there illustrated. As best seen in FIG. 1, the adjustable wrench here comprises a body 12 which includes an elongate handle portion 14 and a head portion 16. Head portion 16 includes a fixed jaw 18 having a grasping face 20 and a movable jaw 22. As shown in FIG. 2, head portion 16 is provided with a transverse bore 24 and a generally vertically extending chamber 26 that is disposed proximate the transverse bore.

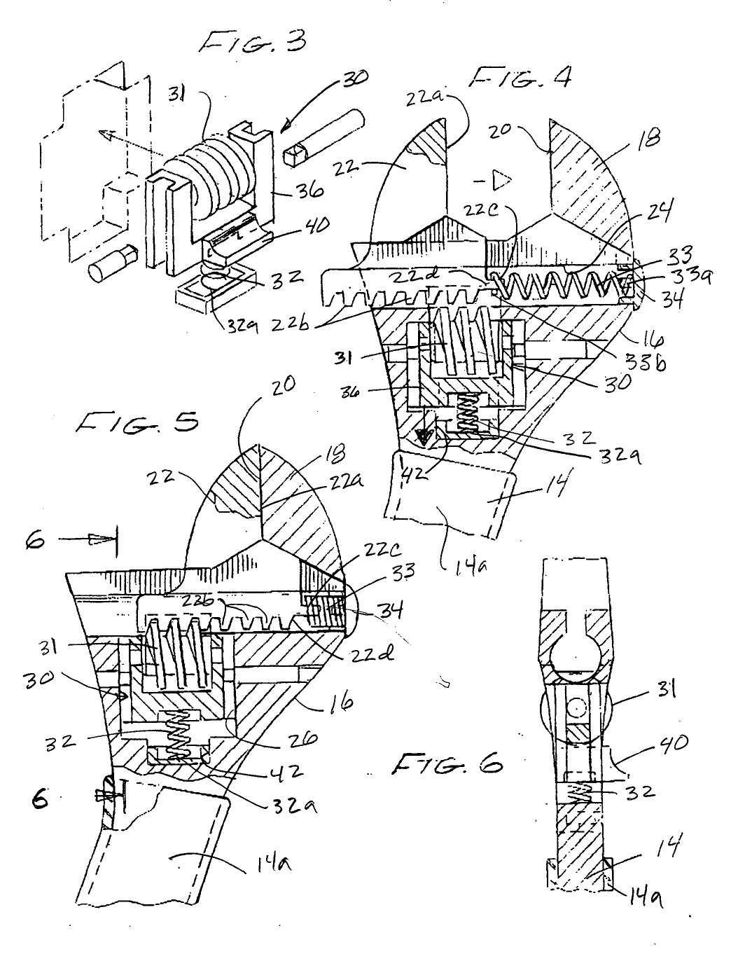

Mounted within chamber 26 is an operator assemblage 30 (FIG. 3) which is slidably movable within the cavity between the first operating position shown in FIG. 2 and the second, retracted position shown in FIG. 4. An operator assemblage biasing means, shown here as a coil spring 32, is carried by head portion 16 for continuously biasing the operator assemblage 30 toward the first operating position.

As illustrated in FIGS. 2, 4 and 5, movable jaw 22 is slidably carried by head portion 16 for movement between the first closed position shown in FIG. 5 and the second open position shown in FIGS. 2 and 4. Movable jaw 22 has a grasping face 22a and a rack defined by a plurality of teeth 22b that are constructed and arranged to operably engage the operator or worm gear component 31 of the operator assemblage 30 when the operator assemblage is in the first operating position. To continuously urge the movable jaw toward the first, closed position, movable jaw biasing means are provided. In the present form of the invention this important biasing means comprises a coil spring 33 that is carried within transverse bore 24. It is to be understood that any suitable spring, such as a leaf spring or the like can be used in lieu of the coil spring. As best seen in FIG. 2, the first end 33a of the coil spring 33 is connected to head portion 16 by means of a connector plug 34 and the second end 33b of the coil spring is connected to an eyelet 22c formed proximate the inboard extremity 22d of the movable jaw.

As illustrated in FIG. 3, the operator assemblage 30 here comprises a carriage 36 which is slidably movable within cavity 26 between a first position shown in FIGS. 2 and 5 and second retracted position shown in FIG. 4. Operator assemblage 30 also includes the previously identified operator or worm gear 31 that is rotatably carried by carriage 36 for engagement with said teeth 22b of movable jaw 22 when the carriage is in the first operating position shown in FIG. 2. Also comprising a part of operator assemblage 30 is finger engaging means for moving carriage 36 toward the second, retracted position against the urging of the operator biasing means. This finger engaging means here comprises an outwardly extending finger engaging member 40 that is affixed to the lower cross member of the carriage 36. As indicated in FIG. 2, body 12 is provided with a vertical bore 42 that receives a cup-like member 35 that supports the lower extremity 32a of coil spring 32.

In using the adjustable wrench of the present invention, the operator grips the rubber or polymer sleeve 14a that covers the central portion of the metal handle 14b of handle portion. Then, using the thumb, the user then exerts a downward pressure, that is a pressure toward handle 14, on the finger engaging member 40 against the urging of coil spring 32. This downward movement of the finger engaging member moves the carriage 36 and the worm gear 31 into the position shown in FIG. 4. With the carriage in this downward position, the movable jaw 22 can be moved to the left as viewed in FIG. 2 against the urging of spring 33. With the jaws of the wrench thusly separated, if desired, the jaws can be maintained in their separated position by releasing the pressure exerted on the finger engaging member thereby permitting the worm gear to engage teeth 22b. The jaws of the wrench can then be suitably positioned about a nut or bolt head end (FIG. 2). By then once again exerting a downward pressure on the finger engaging member, the worm gear will move out of engagement with the teeth on the movable jaw 22 and spring 33 will automatically bring the movable jaw into engagement with the nut or bolt head in the manner shown in FIG. 2. With the jaws in engagement with the nut or bolt head release of the downward pressure exerted on the finger engaging member will once again cause spring 32 to urge the worm gear into the upward operating position shown in FIGS. 2 and 5. As the worm gear moves into the operating position the teeth of the worm gear will engage the teeth 22b of the movable jaw in a manner to hold the jaw in the closed position. Any loosening of the movable jaw during tightening or loosening of the nut or bolt can be compensated for by manipulation of the worm gear in a conventional manner, the inclusion of the spring closer mechanism with the “worm gear” exerts pressure on the worm gear thus lessening its tendency to “travel” during tightening or loosening of the nut or bolt. To permit separation of the movable jaw from the fixed jaw, the operator need only manipulate the “worm gear” in the manner just mentioned or the operator need only to exert a downward pressure on the finger engaging member 40 which allows the movable jaw 22 to be manually moved away from the gripping surfaces of the nut or bolt head.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An adjustable wrench comprising:
(a) A body including an elongate handle portion and a head portion, said head portion including a fixed jaw having a grasping face and being provided with a transverse bore and a chamber spaced apart from said transverse bore;
(b) an operator assemblage slidably movable within said chamber between a first position and a second position, said operator assemblage including an operator;
(c) operator assemblage biasing means carried by said body for biasing said operator assemblage toward said first position;
(d) a movable jaw slidably carried by said head portion for movement between a first position and a second position, said movable jaw having a grasping face and a plurality of teeth constructed and arranged to be operably engaged by said operator when said operator assemblage is in first position; and
(e) a movable jaw biasing means connected to said body for biasing said movable jaw toward said first position.

2. The adjustable wrench as defined in claim 1 in which said operator assemblage includes a carriage slidably movable within said chamber between a first and a second position and in which said operator is rotatably carried by said carriage.

3. The adjustable wrench as defined in claim 2 in which said operator assemblage further includes finger engaging means for moving said carriage toward said second position against the urging of said operator assemblage biasing means.

4. The adjustable wrench as defined in claim 3 in which said body portion is provided with a vertical bore proximate said chamber and in which said operator assemblage biasing means comprises a coiled spring disposed within said vertical bore.

5. The adjustable wrench as defined in claim 4 in which said movable jaw biasing means comprises a connector disposed within said transverse bore and a coil spring having first and second ends, said first end of said coil spring being connected to said connector and said second end of said coil spring being connected to said movable jaw.

6. An adjustable wrench comprising:
(a) A body including an elongate handle portion and a head portion, said head portion including a fixed jaw having a grasping face and being provided with a transverse bore and a chamber spaced apart from said transverse bore;
(b) an operator assemblage slidably movable within said chamber between a first position and a second position, said operator assemblage comprising:
(i) a carriage slidably movable within said chamber between a first and second position; and
(ii) a worm gear rotatably carried by said carriage for engagement with said teeth of said movable jaw when said carriage is in said first position;
(c) operator assemblage biasing means carried by said body for biasing said operator assemblage toward said first position;
(d) a movable jaw slidably carried by said head portion for movement between a first position and a second position, said movable jaw having a grasping face and a plurality of teeth constructed and arranged to operably engage said operator when said operator is in first position; and
(e) a movable jaw biasing means connected to said body for biasing said movable to jaw toward said first position.

7. The adjustable wrench as defined in claim 6 in which said operator assemblage further includes finger engaging means for moving said carriage toward said second position against the urging of said operator assemblage biasing means.

8. The adjustable wrench as defined in claim 6 in which said body portion is provided with a vertical bore and in which said operator assemblage biasing means comprises a coiled spring disposed within said vertical bore.

9. The adjustable wrench as defined in claim 6 in which said movable jaw biasing means comprises a connector plug disposed within said transverse bore and a coil spring having first and second ends, said first end of said coil spring being connected to said connector plug and said second end of said coil spring being connected to said movable jaw.

10. The adjustable wrench as defined in claim 6 in which said head portion is provided with indicia corresponding to the distance between said grasping face of said fixed jaw and said grasping face of said movable jaw.

11. An adjustable wrench comprising:
(a) A body including an elongate handle portion and a head portion, said head portion including a fixed jaw having a grasping face and being provided with a transverse bore and a chamber spaced apart from said transverse bore;
(b) an operator assemblage slidably movable within said chamber between a first position and a second position, said operator assemblage comprising:
(i) a carriage slidably movable within said chamber between a first and second position;
(ii) a worm gear rotatably carried by said carriage for engagement with said teeth of said movable jaw when said carriage is in said first position; and
(iii) finger engaging means connected to said carriage for moving said carriage toward said second position against the urging of said operator assemblage biasing means;
(c) operator assemblage biasing means carried by said body for biasing said operator assemblage toward said first position;
(d) a movable jaw slidably carried by said head portion for movement between a first position and a second position, said movable jaw having a grasping face and a plurality of teeth constructed and arranged to operably engage said worm gear when said operator assemblage is in first position; and
(e) a movable jaw biasing means connected to said body for biasing said movable to jaw toward said first position, said movable jaw biasing means comprising a connector plug disposed within said transverse bore and a coil spring having first and second ends, said first end of said coil spring being connected to said connector plug and said second end of said coil spring being connected to said movable jaw.

12. The adjustable wrench as defined in claim 11 in which said body portion is provided with a vertical bore and in which said operator assemblage biasing means comprises a coiled spring disposed within said vertical bore.

13. The adjustable wrench as defined in claim 11 in which said finger engaging means comprises an outwardly protruding finger engaging member connected to said carriage.

14. The adjustable wrench as defined in claim 11 in which said handle portion includes a metal handle and a gripping sleeve covering said metal handle.

15. The adjustable wrench as defined in claim 15 in which said gripping sleeve is constructed from a polymer.
